(19) United States
(12) Patent Application Publication
(10) Pub. No.: US 2025/0313262 A1
(43) Pub. Date: Oct. 9, 2025

(54) STEER-BY-WIRE STEERING DEVICE, POWER SUPPLY SYSTEM AND VEHICLE INCLUDING THE SAME

(71) Applicant: HL MANDO CORPORATION, Gyeonggi-do (KR)

(72) Inventors: Taesik KIM, Gyeonggi-do (KR); Jaehoon BAE, Gyeonggi-do (KR)

(21) Appl. No.: 19/173,547

(22) Filed: Apr. 8, 2025

(30) Foreign Application Priority Data
Apr. 8, 2024 (KR) 10-2024-0047217
Jan. 24, 2025 (KR) 10-2025-0011863

(51) Int. Cl. B62D 5/04; B60R 16/03; B62D 5/00; H02J 9/06

(52) U.S. Cl. CPC B62D 5/046; B60R 16/03; B62D 5/006; H02J 9/06

(57) ABSTRACT

A power supply system for supplying power to a steer-by-wire steering device includes a high-voltage power source, a converter for converting voltage of the high-voltage power source into an operating voltage, a low-voltage power source, a steer-by-wire steering device including a main system and a sub system, and an uninterruptible power supply for receiving power from the low-voltage power source and supplying the power to a sub system, in which the uninterruptible power supply includes a first charging circuit, a first capacitor, and one or more switch elements, and turns on a first switch element connected to the first charging circuit to apply a boosted operating voltage to the main system in a case where a vehicle is in a parking operation.

### CROSS-REFERENCE TO RELATED APPLICATIONS

This application claims the priorities to Korean Patent Application No. 10-2024-0047217 filed on Apr. 8, 2024 and Korean Patent Application No. 10-2025-0011863 filed on Jan. 24, 2025, in the Korean Intellectual Property Office, the disclosure of which is incorporated herein by reference in their entireties.

### BACKGROUND

### Field

The present embodiments relate to a steer-by-wire steering device and power supply technology.

### Description of the Related Art

The development of a power supply system including an electric steering device that provides optimal steering conditions to a driver by driving a motor in an electronic control unit (ECU) according to operating conditions of a vehicle to achieve various steering operations is actively underway.

The above-mentioned electric power steering device includes electro-hydraulic power steering (EHPS), motor driven power steering (MDPS), or electric power steering (EPS). In particular, the electric power steering device can provide a lighter and more comfortable steering feel because the electric power steering device assists power through a rotational force of a motor, unlike the hydraulic method that assists power by forming hydraulic pressure from a pump in a case where a driver performs a parking operation.

However, the current power supply system structure, which generally supplies 12 V, has a problem in that in a case where the vehicle is in a parking operation, a rotation angle of a wheel is not large enough compared to a rotation angle of a steering wheel due to the capacity limit of the electric steering device, so that a fast rack speed cannot be provided.

### SUMMARY

The present embodiments may provide a steer-by-wire steering device and power supply technology.

In one aspect, the present embodiments may provide a power supply system for supplying power to a steer-by-wire steering device including a main system and a sub system, the power supply system including: a high-voltage power source; a converter configured to convert voltage of the high-voltage power source into an operating voltage; a low-voltage power source; and an main uninterruptible power supply configured to receive the operating power from the converter and supply the operating power to the main system of the steer-by-wire steering device; a sub uninterruptible power supply configured to receive the operating power from the converter and supply the operating power to the sub system of the steer-by-wire steering device, wherein the main uninterruptible power supply includes a first charging circuit, a first capacitor, and one or more switch elements including a first switch element connected to the first charging circuit, and wherein the main uninterruptible power supply is configured to turn on the first switch element connected to the first charging circuit to apply a boosted operating voltage to the main system of the steer-by-wire steering device when a vehicle is in a parking operation.

In another aspect, the present embodiments may provide a steer-by-wire steering device, including: a main system including a first steering feedback actuator configured to provide a steering reaction force and a first road wheel actuator configured to provide a steering force; a sub system including a second steering feedback actuator configured to provide the steering reaction force and a second road wheel actuator configured to provide the steering force; wherein the main system is configured to receive an operating voltage from one of a converter and a main uninterruptible power supply comprising a first charging circuit, a first capacitor, and one or more switch elements including a first switch element connected to a first charging circuit, wherein the first switch element connected to the first charging circuit is configured to be turned on to receive a boosted operating voltage when a vehicle is in a parking operation.

In still another aspect, the present embodiments may provide a vehicle including: a high-voltage power source; a motor configured to receive power from the high-voltage power source and apply a force to the vehicle; a converter configured to convert a voltage of the high-voltage power source into an operating voltage, a low-voltage power source, a steer-by-wire steering device including a main system and a sub system, and an main uninterruptible power supply configured to receive the operating power from the converter and supply the operating power to the main system of the steer-by-wire steering device; a sub uninterruptible power supply configured to receive the operating power from the converter and supply the operating power to the sub system of the steer-by-wire steering device, wherein the main uninterruptible power supply includes a first charging circuit, a first capacitor, and one or more switch elements comprising a first switch element connected to the first charging circuit, and wherein the main uninterruptible power supply is configured to turn on the first switch element connected to the first charging circuit to apply a boosted operating voltage to the main system of the steer-by-wire steering device when the vehicle is in a parking operation.

The present embodiments can provide the power supply technology for the steer-by-wire steering device.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic diagram illustrating a steer-by-wire steering device to which the present embodiments can be applied.

FIG. 2 is a diagram for explaining the operation of the steer-by-wire steering device.

FIG. 3 is a diagram for explaining a power supply system according to one embodiment.

FIG. 4 is a diagram for specifically explaining an uninterruptible power supply according to one embodiment.

FIG. 5 is a diagram for explaining changes in a motor speed of a vehicle boosted by the present device according to another embodiment.

FIG. 6 is a diagram for explaining the configuration of a steer-by-wire steering device according to still another embodiment.

FIG. 7 is a diagram for explaining the configuration of a vehicle according to still another embodiment.

### DETAILED DESCRIPTION OF THE EMBODIMENT

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

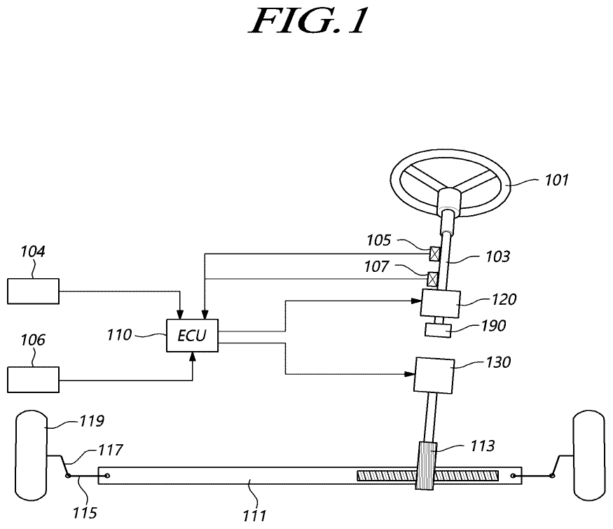

FIG. 1 is a schematic diagram illustrating a steer-by-wire steering device to which the present embodiments can be applied.

Referring to FIG. 1, in the steer-by-wire steering device according to the present embodiments, an angle sensor 105 and a torque sensor 107 are coupled to one side of a steering shaft 103 connected to a steering wheel 101, and in a case where a driver operates the steering wheel 101, the angle sensor 105 and the torque sensor 107 detect the operation of the driver and send an electric signal to an electronic control device 110 so that a steering shaft motor 120 and a pinion shaft motor 130 may be operated.

The electronic control device 110 may control the steering shaft motor 120 and the pinion shaft motor 130 based on the electric signal transmitted from the angle sensor 105 and the torque sensor 107 and electric signals transmitted from various other sensors mounted on the vehicle.

The steering shaft motor 120 is connected to a reducer 145 that reduces the rotational speed of the motor, and during normal driving, the steering shaft motor provides a reaction force to the steering shaft 103 so that the driver can feel a steering reaction force in the opposite direction when the driver operates the steering wheel 101, and during autonomous driving, steering is performed by the control of the electronic control device 110 without the intervention of the driver's will.

The pinion shaft motor 130 slides a rack bar 111 connected to a pinion shaft 113 to steer the wheels 119 on both sides through a tie rod 115 and a knuckle arm 117.

However, for convenience of explanation, the drawings in these embodiments illustrate an example in which the angle sensor 105 and the torque sensor 107 are provided on the steering shaft 103, a vehicle speed sensor 104 for transmitting steering information to the electronic control device 110, and a pinion shaft rotation angle sensor 106 are provided, but in addition, a motor position sensor, various types of radar and lidar, and image sensors such as cameras may be provided, and detailed descriptions thereof will be omitted below.

In this steer-by-wire steering device, since the steering wheel 101 and the wheel 119 are not mechanically connected, the steering shaft motor 120 provides a reaction force to the driver. In addition, the pinion shaft motor 130 provides a steering force to the rack bar 111. The pinion shaft motor 130 and the rack bar 111 can be coupled in various ways, and there is no limitation to the coupling method.

Hereinafter, a motor that provides a steering reaction force to the steering wheel in a steer-by-wire steering device is described as a steering feedback actuator (SFA). In addition, the above-described pinion shaft motor is an actuator that transmits the driver's steering intention to the vehicle wheels and moves the wheels, and is described as a road wheel actuator (RWA).

Since the steer-by-wire (SbW) steering device has no mechanical connection between the steering wheel and the rack bar, it may be difficult to physically control the steering of the vehicle when a failure occurs in related systems such as the electronic control unit. In addition, with the current power system structure, when the vehicle is in a parking operation, the rotation angle of the wheels may not be sufficiently large compared to the rotation angle of the steering wheel due to the capacity limit of the electric steering device, making it difficult to control the steering of the vehicle.

Therefore, technology that controls the size of the voltage applied to the steer-by-wire steering device according to the driving conditions of the vehicle while providing stability in the steer-by-wire steering device is becoming important.

Accordingly, the present disclosure proposes a method of providing stability to the steering device while controlling the size of the voltage applied depending on the driving situation by mounting two uninterruptible power supplies on the steer-by-wire steering device mounted on a vehicle.

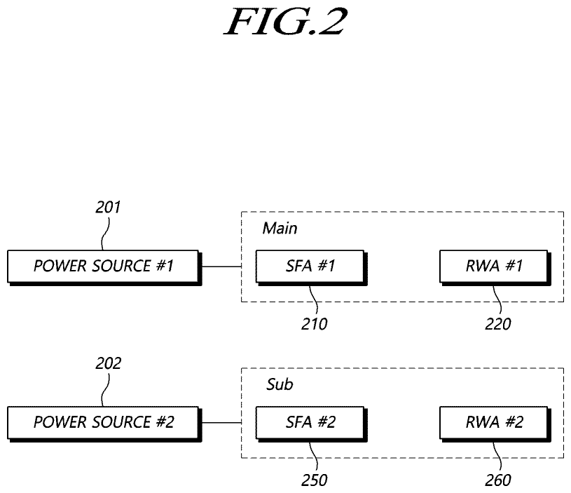

The above-described method is described in detail with reference to FIG. 2.

FIG. 2 is a diagram for explaining the configuration of a power supply system according to one embodiment.

Referring to FIG. 2, the power supply system may include at least one power system, and the power system may be connected to the steer-by-wire steering device and operated. The power system may supply power to a motor system. The steer-by-wire steering device may include the motor system, and the motor system may include a Main system and a Sub system. In addition, since the Main system and the Sub system are configured, even if an abnormality occurs in any one of the Main system and the Sub system, the steer-by-wire steering device may perform normal operation due to the operation of the system in which the abnormality does not occur. The present disclosure may refer to the aforementioned Main system as a main system, and the aforementioned Sub system as a sub system.

The main system and sub system described above may be configured as physically separate motors. Alternatively, the main system and sub system may be redundant by building the system in the form of dual windings on one motor.

For example, the main system of the steer-by-wire steering device may include a first steering feedback actuator 210 and a first road wheel actuator 220. The first steering feedback actuator 210 may be configured to provide a steering reaction force when the driver performs a steering operation using the steering wheel, and the first road wheel actuator 220 may be configured to provide a steering force. The present disclosure may refer to the first steering feedback actuator 210 as SFA #1 (Steering Feedback Actuator #1), and the first road wheel actuator 220 may refer to RWA #1 (Road Wheel Actuator #1).

In addition, the sub system of the steer-by-wire steering device may include a second steering feedback actuator 250 and a second road wheel actuator 260. The second steering feedback actuator 250 may also be configured to provide the steering reaction force when the driver performs the steering operation using the steering wheel, like the first steering feedback actuator 210 described above, and the second road wheel actuator 260 may also be configured to provide the steering force, like the first road wheel actuator 220 described above. In the present disclosure, the second steering feedback actuator 250 described above may be referred to as SFA #2 (Steering Feedback Actuator #2), and the second road wheel actuator 260 may be referred to as RWA #2 (Road Wheel Actuator #2).

The first steering feedback actuator 210 and the second steering feedback actuator 250 described above may be configured as physically separate motors. Alternatively, the first steering feedback actuator 210 and the second steering feedback actuator 250 may supply power in the form of dual windings on one motor. For example, the first steering feedback actuator 210 and the second steering feedback actuator 250 may be configured as dual windings that construct winding and an inverter structure in one motor.

Similarly, the first road wheel actuator 220 and the second road wheel actuator 260 may be separated into different physical motors. Alternatively, the first road wheel actuator 220 and the second road wheel actuator 260 may provide power in the form of dual windings on one motor. For example, the first road wheel actuator 220 and the second road wheel actuator 260 may have dual windings that construct winding and an inverter structure in one motor.

In another example, the main system and the sub system may cooperate to provide normal output. For example, the first steering feedback actuator 210 may provide 50% output and the second steering feedback actuator 250 may provide 50% output to provide 100% output in a normal condition. Similarly, the first road wheel actuator 220 may provide 50% output and the second road wheel actuator 260 may provide 50% output to provide 100% output in the normal condition.

As another example, a redundant system may be constructed in which the main system provides 100% output in the normal condition, but the sub system provides 50 to 100% output if abnormality occurs in the main system.

The above-mentioned redundant system of the main system and sub system is only one example and may be constructed in various ways as needed without being limited to the above-mentioned one.

Meanwhile, the power system that supplies power to the main system and the sub system may also require redundancy. For example, power source #1 201 may be constructed to supply operating power to the main system, and power source #2 202 may be constructed to supply operating power to the sub system.

Each of the aforementioned power systems may include a high-voltage power source that applies a high voltage and a converter is configured to convert a voltage output from the high-voltage power source into an operating voltage.

Through this, stability may be secured through an appropriate redundancy structure not only in the event of a failure in the motor system but also in the event of a failure in the power system.

The structure of the steer-by-wire steering device is only one example presented for explanation, and the internal structure of the steer-by-wire steering device is not limited to the above-described structure and may have various structures as needed, such as a triple-redundant structure, a power sharing structure, a structure in which only the RWA is redundant, or the like.

In the case of the converter mentioned above, it is difficult to install the converter in the redundancy structure as the converter is expensive equipment in terms of cost and size of the power supply system.

Therefore, the present disclosure proposes a method for providing convenience of operation to the driver by dually installing an uninterruptible power supply (UPS) in the steer-by-wire steering device while simplifying the power supply system by using only one converter.

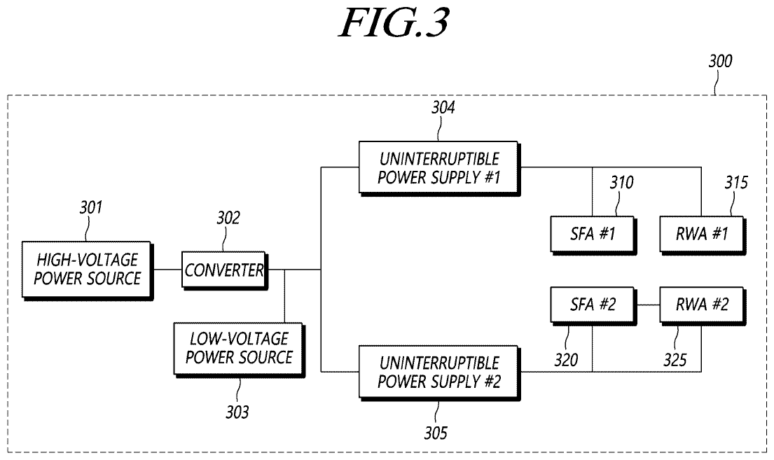

This is explained in detail with examples starting from FIG. 3.

FIG. 3 is a diagram for explaining a power supply system according to one embodiment.

Referring to FIG. 3, the power supply system of the present disclosure may include a high-voltage power source, a converter and a low-voltage power source.

Specifically, a power supply system 300 of the present disclosure may include a high-voltage power source 301, a converter 302 that converts the voltage of the high-voltage power source 301 into an operating voltage, a low-voltage power source 303, a main uninterruptible power supply 304, main systems 310 and 315 of steer-by-wire steering devices 310, 315, 320, and 325, a sub uninterruptible power supply 305, and sub systems 320 and 325 steer-by-wire steering devices 310, 315, 320, and 325.

For example, the high-voltage power source 301 of the present disclosure may be a power supply device that supplies a high voltage of 800 V or higher. For example, the high-voltage power source 301 may be a battery of an electric vehicle, or the like. The high-voltage power source 301 may include a battery, a capacitor, or the like.

As another example, the converter 302 of the present disclosure may convert the high voltage of the high-voltage power source 301 into the operating voltage. The converter 302 may reduce the supplied high voltage to the operating voltage. The operating voltage may be set to various values depending on the vehicle. For example, the operating voltage may be set to 12 V, 24 V, or 48 V depending on the vehicle.

The operating voltage converted by the converter 302 may be applied to the main system through the main uninterruptible power supply 304 of the present disclosure, or to the sub system through the sub uninterruptible power supply 305.

As another example, the low-voltage power source 303 of the present disclosure may temporarily supply the operating voltage when a failure occurs in the high-voltage power source 301 or the converter 302. For example, the low-voltage power source 303 may include a battery, a capacitor, or the like.

As another example, the power supply system 300 of the present disclosure may include the main systems 310 and 315, the sub systems 320 and 325, the main uninterruptible power supply 304, and the sub uninterruptible power supply 305.

The main systems 310 and 315 of steer-by-wire steering devices 310, 315, 320, and 325 of the present disclosure may include the first steering feedback actuator 310 for providing the steering reaction force and the first road wheel actuator 315 for providing the steering force. The sub systems 320 and 325 of steer-by-wire steering devices 310, 315, 320, and 325 may include the second steering feedback actuator 320 for providing the steering reaction force and the second road wheel actuator 325 for providing the steering force.

The first steering feedback actuator 310 and the second steering feedback actuator 320 of the present disclosure may provide the steering reaction force when a driver performs the steering operation using the steering wheel. When the first steering feedback actuator 310 included in the main systems 310 and 315 fails, the second steering feedback actuator 320 included in the sub systems 320 and 325 may be operated.

The first road wheel actuator 315 and the second road wheel actuator 325 of the present disclosure are motors that directly apply the steering force to the drive shaft of the vehicle, and in a case where the first road wheel actuator 315 included in the main systems 310 and 315 fails, the second road wheel actuator 325 included in the sub systems 320 and 325 may be operated.

In this way, the present disclosure may configure the power supply system 300 of the steer-by-wire steering device so that an emergency steering operation may be performed on the vehicle through the sub systems 320 and 325 in the event of occurring of an abnormality in the main systems 310 and 315 by duplicating the steering feedback actuator and the road wheel actuator.

The main uninterruptible power supply 304 of the present disclosure may be configured to receive an operating power from at least one of the converter 302 or the low-voltage power source 303 and supply the operating power to the main systems 310 and 315 of the steer-by-wire steering device, and the sub uninterruptible power supply 305 may be configured to receive the operating power from at least one of the converter 302 and the low-voltage power source 303 and supply the operating power to the sub systems 320 and 325 of the steer-by-wire steering device when the main uninterruptible power supply 304 described above fails. In the present disclosure, the main uninterruptible power supply 304 may be referred to as an uninterruptible power supply #1, and the sub uninterruptible power supply 305 may be referred to as an uninterruptible power supply #2. When the main uninterruptible power supply 304 described above fails, the operation of the sub uninterruptible power supply 305 may be performed as needed.

In addition, in order to prevent a short circuit problem in the power system, at least one of the main uninterruptible power supply 304 and the sub uninterruptible power supply 305 may include a blocking circuit. The blocking circuit may be configured to interrupt current flowing through the main uninterruptible power supply or the sub uninterruptible power. In addition, The blocking circuit may be configured to interrupt current flowing through SbW. The blocking circuit may mean a circuit breaker and may prevent power leakage in the event of a short circuit problem. For example, the blocking circuit may include an eFuse circuit or a switch circuit.

In addition, the steer-by-wire (SbW) system of an autonomous vehicle may not be equipped with a steering feedback actuator but may only be equipped with a road wheel actuator. In order to apply this to the operation of an autonomous vehicle, the main uninterruptible power supply 304 of the present disclosure may be set to communicate with the first road wheel actuator 315 rather than the first steering feedback actuator 310, and the sub uninterruptible power supply 305 may be set to communicate with the second road wheel actuator 325 rather than the second steering feedback actuator 320.

In addition, the main uninterruptible power supply of the present disclosure may include a first charging circuit, a first capacitor, and one or more switch elements, and may control the size of power supplied to the main system by controlling the one or more switch elements, and the sub uninterruptible power supply may include a second charging circuit, a second capacitor, and one or more other switch elements, and may control the size of power supplied to the sub system by controlling the one or more switch elements when the main uninterruptible power supply is in a failure state.

Therefore, the main system is configured to receive an operating voltage from one of the converter and the main uninterruptible power supply comprising the first charging circuit, the first capacitor, and one or more switch elements including the first switch element connected to the first charging circuit. Also, The first switch element connected to the first charging circuit switch element is configured to be turned on to receive a boosted operating voltage when a vehicle is in a parking operation.

Also, a sub uninterruptible power supply includes a second charging circuit, a second capacitor, and one or more other switch elements comprising a fourth switch element connected to the second charging circuit, and the sub system is configured to turn on the fourth switch element connected to the second charging circuit switch element to receive a boosted operating voltage when the vehicle is in the parking operation and the main uninterruptible power supply is in a failure state.

Therefore, the power supply system 300 of the present disclosure may safely control the steering of the vehicle even when an abnormality occurs in any one of the main system, sub system, and power supply line.

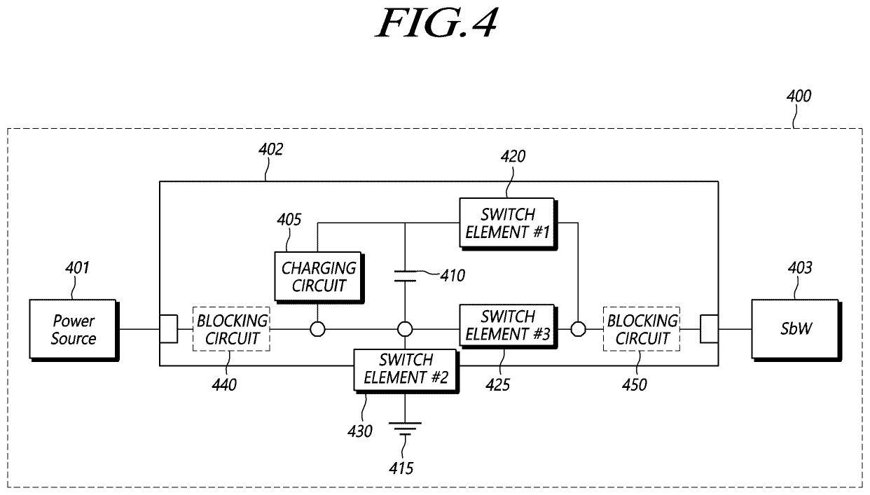

FIG. 4 is a diagram for specifically explaining an uninterruptible power supply according to one embodiment.

Referring to FIG. 4, a power supply system 400 of the present disclosure may include two uninterruptible power supplies, and control the size of power supplied to the main system or the sub system through the operation of each uninterruptible power supply as needed.

Conventional power supply systems have used a converter that is connected to a high-voltage power source and converts high voltage into the operating voltage, and a converter that is connected to a low-voltage power source and converts low voltage into the operating voltage.

In this regard, the present disclosure proposes a method of reducing the number of converters, which are expensive equipment included in the power supply system, to one, while connecting each of two uninterruptible power supplies to the main system and the sub system, thereby controlling the size of the voltage applied to the main system or the sub system, thereby enabling boosted operation or preventing overvoltage in steering control of a vehicle.

A Power Source 401 of FIG. 4 includes a high-voltage power source, a converter, and a low-voltage power source, and an SbW 403 includes a main system and a sub system. For convenience of explanation, the present disclosure illustrates only one of the two uninterruptible power supplies in FIG. 4. Therefore, the uninterruptible power supply 402 illustrated in FIG. 4 may be the main uninterruptible power supply of the present disclosure, and may control the operating power applied from the Power Source 401 from the main uninterruptible power supply to supply the changed power to the main system of the SbW 403. Alternatively, the uninterruptible power supply 402 illustrated in FIG. 4 may be the sub uninterruptible power supply of the present disclosure, and may control the operating power applied from the Power Source 401 from the sub uninterruptible power supply to supply the changed power to the sub system of the SbW 403.

As illustrated in FIG. 4, the uninterruptible power supply 402 of the present disclosure may include a charging circuit 405, a capacitor 410, and three one or more switch elements including a first switch element connected to the charging circuit. In the present disclosure, the charging circuit included in the main uninterruptible power supply may be referred to as a first charging circuit 405, the capacitor may be referred to as a first capacitor 410, and the three switch elements may be referred to as a first switch element 420, a second switch element 430, and a third switch element 425, respectively. In addition, the first switch element 420 may be connected to the charging circuit 405, the second switch element 430 may be connected to a ground 415, and the third switch element 425 may be connected to the capacitor 410. In the present disclosure, the first switch element 420 may be referred to as a switch #1 or a switch element #1, the second switch element 430 may be referred to as a switch #2 or a switch element #2, and the third switch element 425 may be referred to as a switch #3 or a switch element #3.

In addition, in the present disclosure, the charging circuit included in the sub uninterruptible power supply may be referred to as the second charging circuit, the capacitor may be referred to as the second capacitor, and the three switch elements may be referred to as the fourth switch element, the fifth switch element, and the sixth switch element, respectively. In addition, the fourth switch element may be connected to the charging circuit, the fifth switch element may be connected to the capacitor, and the sixth switch element may be connected to the ground. In the present disclosure, the fourth switch element may be referred to as a switch #4 or a switch element #4, the fifth switch element may be referred as a switch #5 or a switch element #5, and the sixth switch element may be referred to as a switch #6 or a switch element #6.

For example, when the vehicle is in a parking operation, the main uninterruptible power supply 402 of the present disclosure may be configured to turn on the first switch element 420 connected to the first charging circuit 405 to apply an operating voltage that is boosted compared to the power supplied from the Power Source 401 to the main system included in the SbW 403. As described above, when the boosted operating power is applied to the main system included in the SbW 403, the rotation angle of the wheel compared to the rotation angle of the steering wheel may be made larger than when the operating power is applied before being boosted.

For example, when the structure of the power supply system is a system in which 12 V is applied, an operating power of 21 V, which is boosted from 12 V by 9 V based on the main uninterruptible power supply 402, may be applied to the main system.

As another example, the main uninterruptible power supply 402 of the present disclosure may turn off the first switch element 420 and turn on the third switch element 425 connected to the first capacitor 410 to apply a reduced operating voltage to the main system included in the SbW 403 when the operating voltage applied to the main system included in the SbW 403 is equal to or more than a preset value. When the operating power applied to the main system included in the SbW 403 becomes excessively high, the main uninterruptible power supply 402 of the present disclosure may lower the power to prevent overvoltage. The above-mentioned preset value is a real number exceeding 0 and may be set in various ways as needed.

For example, when the structure of the power supply system is a system in which 12 V is applied, and the operating power is boosted from 12 V to over 24 V based on the main uninterruptible power supply 402, the boosted operating voltage may be controlled to be lowered by the operation of the switch element included in the main uninterruptible power supply 402 to prevent overvoltage.

As another example, the main uninterruptible power supply 402 of the present disclosure may is configured to turn on the first switch element 420 connected to the first charging circuit 405 and the second switch element 430 connected to the ground 415 to supply power to the main system included in the SbW 403 for a preset period of time when at least one of the high-voltage power source and the converter included in the Power Source 401 and the low-voltage power source fail.

The main uninterruptible power supply 402 of the present disclosure operates the voltage charged in the capacitor 410 to move the vehicle to a safe location even in a failure state when at least one of the high-voltage power source and converter included in the Power Source 401 fails and the low-voltage power source also fails, and thus, power cannot be supplied to the main system included in the SbW 403.

For example, if the structure of the power supply system is a system in which 12 V is applied, and both the high-voltage power source and the low-voltage power source are in a failure state, the 9 V voltage charged in the main uninterruptible power supply 402 may be supplied to the main system for about 10 minutes.

Even in this case, if an abnormality occurs in the operation of the main

uninterruptible power supply 402, the vehicle may be moved to a safe location with 50% to 100% output performance for a limited time through the operation of the sub uninterruptible power supply.

The sub uninterruptible power supply of the present disclosure also includes a second charging circuit, a second capacitor, and one or more switch elements like the main uninterruptible power supply, and may control the size of the power by controlling the one or more switch elements when the main system is in a failure state.

For example, when the vehicle is in a parking operation and the main uninterruptible power supply is in a failure state, the sub uninterruptible power supply of the present disclosure may is configured to turn on the fourth switch element connected to the second charging circuit to apply a boosted operating voltage to the sub system included in the SbW. As described above, when the boosted operating power is applied to the sub system included in the SbW, the rotation angle of the wheel compared to the rotation angle of the steering wheel may be made larger than in a case where the operating power is applied before being boosted, and it is possible to cope with a failure state of the main system.

As another example, the sub uninterruptible power supply of the present disclosure may turn off the fourth switch element and turn on the fifth switch element connected to the second capacitor to apply a reduced operating voltage to the sub system included in the SbW when the operating voltage applied to the sub system included in the SbW is equal to or more than a preset value. When the operating power applied to the sub system included in the SbW becomes excessively high, the sub uninterruptible power supply of the present disclosure may lower the power to prevent overvoltage.

As another example, the sub uninterruptible power supply of the present disclosure may turn on the fourth switch element connected to the second charging circuit and the sixth switch element connected to the ground to supply power to the main system included in the SbW for a preset period of time when at least one of the high-voltage power source and the converter included in the Power Source and the low-voltage power source and the main system included in the SbW fail. The sub uninterruptible power supply of the present disclosure may operate the voltage charged in the capacitor to move the vehicle to a safe location even in a failure state when at least one of the high-voltage power source and the converter included in the Power Source fails and the low-voltage power source and the main system also fail, and thus, power cannot be supplied to the main system included in the SbW.

The power supply system 400 of the present disclosure may organize the operation of the switch element included in each uninterruptible power supply as follows.

For example, when the boosted power is to be supplied to the main system in the main uninterruptible power supply, the first switch element connected to the first charging circuit may be turned on, the second switch element connected to the ground may be turned off, and the third switch element connected to the first capacitor may be turned off.

As another example, when a reduced power supply is to be supplied to the main system in the main uninterruptible power supply, the first switch element connected to the first charging circuit may be turned off, the second switch element connected to ground may be turned off, and the third switch element connected to the first capacitor may be turned on.

As another example, in the case where at least one of the high-voltage power source and the converter included in the power source and the low-voltage power source in the main uninterruptible power supply are in a failure state, the first switch element connected to the first charging circuit may be turned on, the second switch element connected to the ground may be turned on, and the third switch element connected to the first capacitor may be turned off.

As another example, when the boosted power is to be supplied to the sub system in the sub uninterruptible power supply, the fourth switch element connected to the second charging circuit may be turned on, the fifth switch element connected to the second capacitor may be turned off, and the sixth switch element connected to the ground may be turned off.

As another example, when the reduced power is to be supplied to the sub system in the sub uninterruptible power supply, the fourth switch element connected to the second charging circuit may be turned off, the fifth switch element connected to the second capacitor may be turned on, and the sixth switch element connected to the ground may be turned off.

As another example, when at least one of the high-voltage power source and the converter and the low-voltage power source included in the power source are in a failure state and the main system or the main uninterruptible power supply is in a failure state in the sub uninterruptible power supply, the fourth switch element connected to the second charging circuit may be turned on, the fifth switch element connected to the second capacitor may be turned off, and the sixth switch element connected to the ground may be turned on.

In addition, in order to prevent a short circuit problem in the power system, at least one of the main uninterruptible power supply and the sub uninterruptible power supply may include at least one of blocking circuits 440 and 450. The blocking circuit 440 may be connected to the power source. The blocking circuit 450 may be connected to SbW. The blocking circuit 440 may be configured to interrupt current flowing through power source 401. In addition, The blocking circuit 450 may be configured to interrupt current flowing through SbW 403. The blocking circuit may mean a circuit breaker and may prevent power leakage in the event of a short circuit problem. For example, the blocking circuit may include an eFuse circuit or a switch circuit. In this way, the power supply system 400 according to the present embodiment may provide stable steering operation of the vehicle efficiently even in various situations.

Although the present disclosure has described that the size of power supplied to SbW may be controlled through the uninterruptible power supply, the above-described SbW is only one example, and the present disclosure may also be applied to a safety critical system such as a brake system.

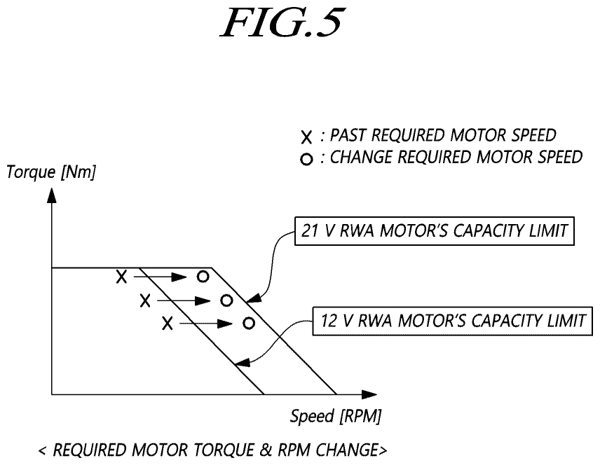

FIG. 5 is a diagram for explaining changes in the motor speed of a vehicle boosted by the present device according to another embodiment.

The power supply system of the present disclosure may supply the operating power to each motor included in the SbW by boosting power supplied from a high-voltage power source or a low-voltage power source through a dual uninterruptible power supply.

Referring to FIG. 5, a rotation speed of the motor being operated is illustrated for torque required to operate a motor corresponding to a y-axis.

For example, when the same numerical torque is operated, the rotation speed of the RWA motor to which 21 V is applied may be determined to be higher than the rotation speed of the RWA motor to which 12 V is applied. Therefore, the uninterruptible power supply of the present disclosure may supply a boosted power so as to provide a higher rotation speed to each motor included in the SbW, and may control the voltage to be lowered to prevent overvoltage when the operating voltage rises equal to or more than the preset value.

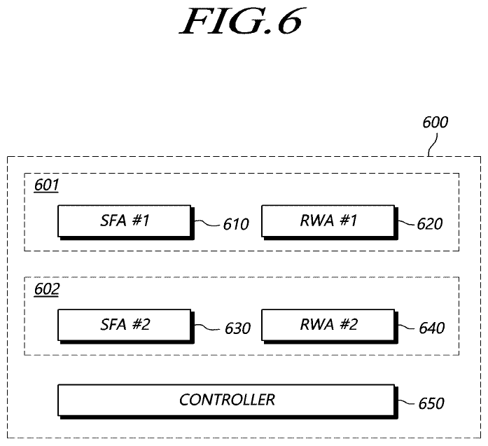

FIG. 6 is a diagram for explaining the configuration of a steer-by-wire steering device according to still another embodiment.

Referring to FIG. 6, a steer-by-wire steering device 600 of the present disclosure may include a main system 601 including a first steering feedback actuator 610 for providing a steering reaction force and a first road wheel actuator 620 for providing a steering force, and a sub system 602 including a second steering feedback actuator 630 for providing a steering reaction force and a second road wheel actuator 640 for providing a steering force.

In addition, the steer-by-wire steering device 600 of the present disclosure may further include a controller 650 that controls the operation of the main system 601 and the sub system 602 described above, in addition to the main system 601 and the sub system 602.

The aforementioned main system 601 may receive the operating voltage from any one of a converter and a low-voltage power source. Additionally, the operating voltage applied to the aforementioned main system may be controlled by the main uninterruptible power supply.

For example, the main system 601 may receive the operating voltage through the converter in a normal situation, and operate by receiving the operating voltage through the low-voltage power source in a situation where at least one of the high-voltage power source and the converter is in a failure state.

In addition, the aforementioned sub system 602 may receive the operating voltage from any one of the converter and the low-voltage power source in the event of a failure of the main system 601 or the main uninterruptible power supply. In addition, the operating voltage applied to the aforementioned sub system may be controlled by the sub uninterruptible power supply.

For example, the sub system 602 may receive power from the sub uninterruptible power supply for a preset period of time when at least one of the high-voltage power source and converter and the low-voltage power source and main system 601 are in a failure state.

Meanwhile, the controller 650 may control the operation of the main system 601 and the sub system 602 so that the vehicle is moved to a safe zone by power supplied from the low-voltage power source or the uninterruptible power supply in a situation where at least one of the high-voltage power source and the converter is in a failure state.

For example, in the event that at least one of the high-voltage power source and the converter is in a failure state, the controller 650 may control the vehicle to move to a safe zone by supporting the steering operation of the vehicle through the low-voltage power source.

In addition, the controller 650 may control the operation of the main system 601 and the sub system 602 so that the vehicle moves to a safe zone by using power supplied from the uninterruptible power supply in a situation where the low-voltage power source is in a failure state. The operation of the sub system 602 described above may be controlled when the main system is in a failure state.

In addition, the power supply operation and detailed configuration for the steer-by-wire steering device 600 are omitted as they are described with reference to FIGS. 3 and 4.

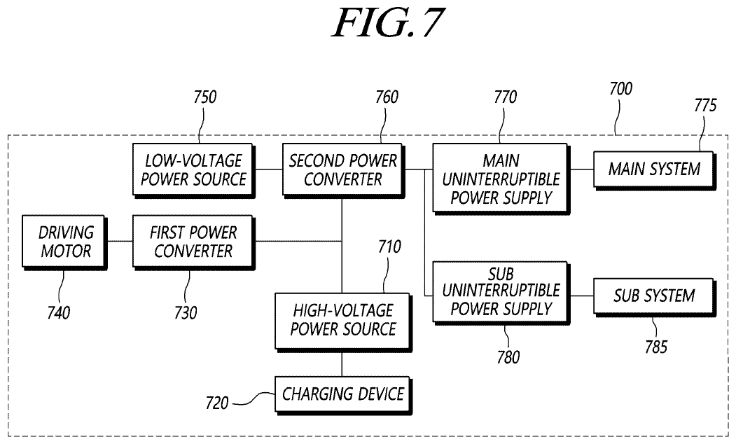

FIG. 7 is a diagram for explaining another vehicle configuration in still another embodiment.

Referring to FIG. 7, a vehicle 700 may include a high-voltage power source 710, a driving motor 740 that receives power from the high-voltage power source 710 and applies driving force to the vehicle 700, a converter that converts the voltage of the high-voltage power source 710 into an operating voltage, a low-voltage power source 750, a steer-by-wire steering device including a main system 775 and a sub system 785, a main uninterruptible power supply 770 that controls an operating voltage applied through a second power converter 760 or the low-voltage power source 750 and supplies the controlled operating voltage to the main system 775, and a sub uninterruptible power supply 780 that controls an operating voltage applied through the second power converter 760 or the low-voltage power source 750 and supplies the controlled operating voltage to the sub system 785.

In addition, the vehicle 700 may further include a charging device 720 for charging the high-voltage power source 710 and a first power converter 730 for applying the high-voltage power source 710 to the driving motor 740.

Here, the vehicle 700 may be an electric vehicle. An electric vehicle may be a vehicle that provides driving force using electric power. The driving motor 740 is a motor that provides driving force to the front wheels and/or rear wheels of the vehicle 700 to move the vehicle. The driving motor 740 may operate at a high voltage, and may be equipped with the first power converter 730 that is different from the second power converter 760. Here, the second power converter 760 means the converter described above.

The main system 775 operates by receiving the operating voltage from any one of the second power converter 760, which is the converter, and the low-voltage power source 750.

For example, when at least one of the high-voltage power source 710 and the second power converter 760 and the low-voltage power source 750 are in a failure state, the main system 775 may be operated by receiving the operating voltage charged to the main uninterruptible power supply 770.

As another example, depending on the size of the operating voltage applied to the main uninterruptible power supply 770, the voltage may be increased and supplied to the main system 775, or the voltage may be lowered and supplied to the main system 775.

Additionally, the sub system 785 operates by receiving the operating voltage from any one of the second power converter 760 which is the converter and the low-voltage power source 750 when the main system 775 fails.

For example, when at least one of the high-voltage power source 710 and the second power converter 760 and the low-voltage power source 750 and the main system 775 are in a failure state, the sub system 785 may be operated by receiving the operating voltage charged to the sub uninterruptible power supply 780.

As another example, depending on the size of the operating voltage applied to the sub uninterruptible power supply 780, the voltage may be increased and supplied to the sub system 785, or the voltage may be lowered and supplied to the sub system 785.

Each of the main uninterruptible power supply 770 and the sub uninterruptible power supply 780 of the present disclosure includes a blocking circuit. The blocking circuit may include an eFuse circuit or a switch circuit. The blocking circuit may also be an electronic fuse circuit including a switch element. Even in a case where the main system 775 or the sub system 785 is short-circuited through the blocking circuit, power leakage may be prevented through circuit blocking.

The specific operation according to the failure of each device in the vehicle 700 is applied as described with reference to FIG. 3. Therefore, to avoid redundant explanation, it is omitted here.

In this way, the vehicle 700 according to the present disclosure may provide cost-saving effects and voltage boosting and overvoltage prevention effects according to driving conditions through an efficient steer-by-wire steering device and power supply system.

The steer-by-wire steering device, the power supply system and the vehicle including the same described above may provide stable and efficient vehicle steering operation.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims.

What is claimed is:

1. A power supply system for supplying power to a steer-by-wire steering device including a main system and a sub system, the power supply system comprising:
a high-voltage power source;
a converter configured to convert a voltage of the high-voltage power source into an operating voltage;
a low-voltage power source;
a main uninterruptible power supply configured to receive an operating power from the converter and supply the operating power to the main system of the steer-by-wire steering device; and
a sub uninterruptible power supply configured to receive the operating power from the converter and supply the operating power to the sub system of the steer-by-wire steering device,
wherein the main uninterruptible power supply includes a first charging circuit, a first capacitor, and one or more switch elements including a first switch element connected to the first charging circuit, and
wherein the main uninterruptible power supply is configured to turn on the first switch element connected to the first charging circuit to apply a boosted operating voltage to the main system of the steer-by-wire steering device when a vehicle is in a parking operation.

2. The power supply system of claim 1, wherein the main system of the steer-by-wire steering device includes a steering feedback actuator configured to provide a steering reaction force and a road wheel actuator configured to provide a steering force.

3. The power supply system of claim 1, wherein:
the one or more switch elements further comprise a second switch element connected to a ground, and
the main uninterruptible power supply is configured to turn on the first switch element connected to the first charging circuit and the second switch element connected to the ground to supply the operating power to the main system of the steer-by-wire steering device for a preset period of time when at least one of the high-voltage power source, the converter, and the low-voltage power source fails.

4. The power supply system of claim 1, wherein:
the one or more switch elements further comprise a third switch element connected to the first capacitor, and
the main uninterruptible power supply is configured to turn off the first switch element and turn on the third switch element connected to the first capacitor to apply a reduced operating voltage to the main system of the steer-by-wire steering device when the operating voltage applied to the main system of the steer-by-wire steering device is equal to or more than a preset value.

5. The power supply system of claim 1, wherein:
the sub uninterruptible power supply includes a second charging circuit, a second capacitor, and one or more other switch elements including a fourth switch element connected to the second charging circuit, and
the sub uninterruptible power supply is configured to turn on the fourth switch element connected to the second charging circuit to apply the boosted operating voltage to the sub system of the sub uninterruptible power supply when the vehicle is in the parking operation and the main uninterruptible power supply is in a failure state.

6. The power supply system of claim 5, wherein:
the one or more other switch elements further comprise a fifth switch element connected to the second capacitor, and
the sub uninterruptible power supply is configured to turn off the fourth switch element and turn on the fifth switch element connected to the second capacitor to apply a reduced operating voltage to the sub system of the steer-by-wire steering device when the operating voltage applied to the sub system of the steer-by-wire steering device is equal to or more than a preset value.

7. The power supply system of claim 1, wherein the main uninterruptible power supply includes a blocking circuit configured to interrupt current flowing through the main uninterruptible power supply.

8. A steer-by-wire steering device, comprising:
a main system including a first steering feedback actuator configured to provide a steering reaction force and a first road wheel actuator configured to provide a steering force; and
a sub system including a second steering feedback actuator configured to provide the steering reaction force and a second road wheel actuator configured to provide the steering force,
wherein the main system is configured to receive an operating voltage from one of a converter and a main uninterruptible power supply comprising a first charging circuit, a first capacitor, and one or more switch elements including a first switch element connected to a first charging circuit, and
wherein the first switch element connected to the first charging circuit switch element is configured to be turned on to receive a boosted operating voltage when a vehicle is in a parking operation.

9. The steer-by-wire steering device of claim 8, wherein:
the one or more switch elements comprise a second switch element connected to a ground, and
the main system is configured to turn on the first switch element connected to the first charging circuit and the second switch element connected to the ground to receive the operating power for a preset period of time when at least one of the converter, a high-voltage power source connected to the converter, and a low-voltage power source fails.

10. The steer-by-wire steering device of claim 8, wherein:
the one or more switch elements comprise a third switch element connected to the first capacitor, and
the main system is configured to turn off the first switch element and turn on a third switch element connected to the first capacitor to receive a reduced operating voltage when the operating voltage applied to the main system is equal to or more than a preset value.

11. The steer-by-wire steering device of claim 8, wherein:
a sub uninterruptible power supply includes a second charging circuit, a second capacitor, and one or more other switch elements comprising a fourth switch element connected to the second charging circuit, and
the sub system is configured to turn on the fourth switch element connected to the second charging circuit switch element to receive a boosted operating voltage when the vehicle is in the parking operation and the main uninterruptible power supply is in a failure state.

12. The steer-by-wire steering device of claim 11, wherein:
the one or more other elements comprise a fifth switch element connected to the second capacitor, and
the sub system is configured to turn off the fourth switch element and turn on the fifth switch element connected to the second capacitor to receive a reduced operating voltage when the operating voltage applied to the sub system is equal to or more than a preset value.

13. The steer-by-wire steering device of claim 8, wherein the main uninterruptible power supply includes a blocking circuit configured to interrupt current flowing through the main uninterruptible power supply.

14. A vehicle comprising:
a high-voltage power source;
a motor configured to receive power from the high-voltage power source and apply a force for the vehicle;
a converter configured to convert a voltage of the high-voltage power source into an operating voltage;
a low-voltage power source;
a steer-by-wire steering device including a main system and a sub system;
a main uninterruptible power supply configured to receive an operating power from the converter and supply the operating power to the main system of the steer-by-wire steering device; and
a sub uninterruptible power supply configured to receive the operating power from the converter and supply the operating power to the sub system of the steer-by-wire steering device,
wherein the main uninterruptible power supply includes a first charging circuit, a first capacitor, and one or more switch elements comprising a first switch element connected to the first charging circuit, and
wherein the main uninterruptible power supply is configured to turn on the first switch element connected to the first charging circuit to apply a boosted operating voltage to the main system of the steer-by-wire steering device when the vehicle is in a parking operation.

15. The vehicle of claim 14, wherein the main system of the steer-by-wire steering device includes a steering feedback actuator configured to provide a steering reaction force and a road wheel actuator configured to provide a steering force.

16. The vehicle of claim 14, wherein:
the one or more switch elements further comprise a second switch element connected to a ground, and
the main uninterruptible power supply is configured to turn on the first switch element connected to the first charging circuit and the second switch element connected to the ground to supply the operating power to the main system of the steer-by-wire steering device for a preset period of time when at least one of the high-voltage power source, the converter, and the low-voltage power source fails.

17. The vehicle of claim 14, wherein:
the one or more switch elements further comprise a third switch element connected to the first capacitor, and
the main uninterruptible power supply is configured to turn off the first switch element and turn on the third switch element connected to the first capacitor to apply a reduced operating voltage to the main system of the steer-by-wire steering device when the operating voltage applied to the main system of the steer-by-wire steering device is equal to or more than a preset value.

18. The vehicle of claim 14, wherein:
the sub uninterruptible power supply includes a second charging circuit, a second capacitor, and one or more other switch elements including a fourth switch element connected to the second charging circuit, and
the sub uninterruptible power supply is configured to turn on the fourth switch element connected to the second charging circuit to apply the boosted operating voltage to the sub system of the sub uninterruptible power supply when the vehicle is in the parking operation and the main uninterruptible power supply is in a failure state.

19. The vehicle of claim 18, wherein:
the one or more other switch elements further comprise a fifth switch element connected to the second capacitor, and
the sub uninterruptible power supply is configured to turn off the fourth switch element and turn on the fifth switch element connected to the second capacitor to apply a reduced operating voltage to the sub system of the steer-by-wire steering device when the operating voltage applied to the sub system of the steer-by-wire steering device is equal to or more than a preset value.

20. The vehicle of claim 14, wherein the main uninterruptible power supply includes a blocking circuit configured to interrupt current flowing through the main uninterruptible power supply.
